(19) United States
(12) Patent Application Publication
(10) Pub. No.: US 2024/0164375 A1
(43) Pub. Date: May 23, 2024

(54) LIQUID DISINFECTANT COMPOSITION AND USE THEREOF

(71) Applicant: HYPRED, DINARD (FR)

(72) Inventors: Grégoire Michel CAILLET, Corseul (FR); Olivier CONNAN, Pleurtuit (FR); Régis Jean-Paul PERION, Dinard (FR); Camille FAUCHON, Rennes (FR)

(73) Assignee: HYPRED, DINARD (FR)

(21) Appl. No.: 18/549,886

(22) PCT Filed: Mar. 11, 2002
(86) PCT No.: PCT/FR2022/050445

§ 371 Date: Nov. 10, 2023

(30) Foreign Application Priority Data
Mar. 11, 2021 (FR) 2102378

(51) Int. Cl. A01N 37/02; A01N 25/16; A01N 31/02; A01N 33/24; A01N 37/36; A01N 41/04; A01P 1/00

(52) U.S. Cl. CPC A01N 37/02; A01N 25/16; A01N 31/02; A01N 33/24; A01N 37/36; A01N 41/04; A01P 1/00

(57) ABSTRACT

The present invention generally relates to a novel liquid disinfectant composition particularly useful in the industrial sector and the agro-food industry. This composition is in concentrated or diluted form and comprises: an aliphatic-chain fatty acid; a glycolic acid, optionally as a mixture with acetic acid; a pH-regulating system, such that the composition, in its diluted form, has a pH lower than 3.8 and preferably lower than 2.0; an ethoxylated fatty alcohol of formula R—(O—C₂H₄)ₙ—OH in which R represents a linear or branched alkyl group having 6 to 12 carbon atoms and n represents an integer between 4 and 8, or a mixture of ethoxylated fatty alcohols; a copolymer of formula

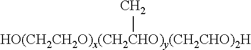

in which x represents an integer between 2 and 15, y represents an integer between 15 and 35, and z represents an integer between 2 and 15, or a mixture of such copolymers; one or more surfactants; and water.

### TECHNICAL FIELD

The present invention generally relates to a novel liquid disinfectant composition particularly useful in the industrial sector and especially in the agro-food industry, as well as in the field of catering and institutional kitchens, livestock hygiene and consumer disinfectant products. A particular object of the invention is a composition which has good physical stability, in concentrated form, and offers high disinfectant efficacy when in diluted form in water. The invention has application, in particular, in clean conditions (disinfectant) or in dirty conditions (detergent/disinfectant), for disinfecting open surfaces, disinfection in washing tunnels and automatic systems, and disinfection by circulation, in particular in so-called clean-in-place systems (CIP).

### PRIOR ART

The main disinfectants currently used in the industrial sector have advantages overall, but also have disadvantages (see table below), such that manufacturers are constantly looking for novel disinfectant compositions there are capable of responding to the increasingly numerous requirements that it is difficult to satisfy simultaneously.

| Disinfectant | | |
|---|---|---|
| products | Advantages | Disadvantages |
| Chlorinated | Fast action | Inactivated in the presence of |
| products | Inexpensive | organic matter |
| | | Corrosive at high doses |
| | | Unstable solution when hot |
| | | and in the light |
| | | Production of irritating fumes |
| Quaternary | Detergent and | Slow action and inhibited by |
| ammonium | disinfectant action | organic matter |
| | Low toxicity | More expensive than |
| | Inexpensive | chlorinated products |
| | Stable | Highly foaming |
| | | Difficult rinsing, high risk of |
| | | residues |
| Peracetic acid | Active at low doses | Irritating vapours |
| | Fast action | Odour in open surface |
| | Inexpensive | application |
| | Reduced environmental | |
| | impact | |
| Aldehydes | Insensitive to the | Slow action |
| | presence of organic | Pungent odour |
| | matter | Toxic and allergenic |
| | Inexpensive | Pollutant |
| | Not corrosive | |
| | Easy rinsing | |

In this context, the present invention aims to solve the technical problem consisting of providing a novel liquid acid disinfectant composition simultaneously having:
a reduced environmental impact through the use of active substances of natural origin and free from nitrogen and phosphorus,
a high effectiveness at the microbiological level (biocidal and yeasticidal)
a high stability, in the concentrated state, under storage conditions (0 to 30° C.) and in particular when cold (temperature less than 5° C.)
low toxicity
   and which is:
very weakly corrosive and compatible with the materials encountered in the food sector
easy rinsing
usable both for an open surface application, in particular with the use of a foam canon, without disadvantages linked to the formation of foam, and for application in a circuit or in a washing tunnel requiring control of the foam,
capable of being manufactured on the industrial scale, in concentrated form, at a relatively low cost.

In order to develop a disinfectant composition having a reduced environmental impact, the inventors turned to the use of active substances based on organic acids of natural origin, and more particularly a combination of at least one aliphatic fatty acid having 8 to 12 carbon atoms, in particular octanoic acid, and glycolic acid.

These relatively short chain organic acids have a satisfactory environmental profile and therefore offer an interesting alternative to disinfectant products which are known for their high environmental impact.

Hence, a family of biocidal products is currently on the market, which are intended in particular for disinfecting surfaces in contact with foodstuffs and animal feeds, and marketed by SOPURA under the name “SOPURCLEAN”, comprising a mixture of octanoic acid and decanoic acid, in combination with various acids such as strong mineral acids (sulfuric, nitric, phosphoric), lactic acid, glycolic acid or citric acid.

The main difficulty linked to the use of relatively short chain organic acids rests in the formulation of a stable composition in the concentrated state, and obtaining a composition that is easy to apply, after dilution, while retaining its disinfectant efficacy.

Indeed these acids have the property of being particularly hydrophobic, and it is extremely difficult to formulate them in the form of a concentrated product, in particular when this must contain (for reasons of cost) a high amount of water that can be as much as approximately 70% by mass.

It has been discovered, and this constitutes the basis of the present invention, that it was possible to solve the technical problem stated above and to achieve the set of desired properties by using precisely chosen components and, in particular, a specific solubilising or hydrotropic system combining an ethoxylated fatty alcohol and a copolymer of polypropylene glycol and polyethylene glycol which will be defined below.

### DISCLOSURE OF THE INVENTION

A first object of the invention relates to a liquid disinfectant composition in concentrated or diluted form, characterised in that it comprises:
an aliphatic-chain fatty acid having 8 to 12 carbon atoms or a mixture of such acids,
glycolic acid, optionally as a mixture with acetic acid, and
a pH-regulating acid system, the type and amount of which is selected such that the composition, in its diluted form, has a pH lower than 2,
an ethoxylated fatty alcohol of formula R—(O—C₂H₄)ₙ—OH in which R represents a linear or branched alkyl group having 6 to 12 carbon atoms and n represents an integer between 4 and 8, or a mixture of such ethoxylated fatty alcohols;
a copolymer of formula:

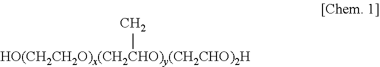

in which x represents an integer between 2 and 15, y represents an integer between 15 and 35, and z represents an integer between 2 and 15; or a mixture of such copolymers,
one or more surfactants,
and water.

A second object of the invention concerns the use of such a composition as described above for disinfecting open surfaces or for disinfecting washing tunnels or circuits.

A third object of the invention concerns a method for disinfecting open surfaces or disinfecting washing tunnels or circuits by applying a composition according to the invention.

### DETAILED DESCRIPTION

### Definitions

In the context of the present invention:
“bactericidal and yeasticidal efficacy under clean conditions”, shall mean the efficacy measured according to standards NF EN 1276, NF EN 1650, NF EN 13697;
“low toxicity” shall mean a composition which does not qualify under the following criteria for classification envisaged by regulation (CE) No 1272/2008:
   Acute toxicity-Category 4 orally (H302: Harmful if swallowed),
   Acute toxicity-Category 4 skin contact (H312: Harmful in contact with skin),
   Skin sensitivity-Category 1A (H317: may cause a skin allergy),
   Acute toxicity-Category 4 inhalation (H332: Harmful if inhaled),
   Respiratory sensitivity-Category 1 (H334: may cause allergy or asthma symptoms or breathing difficulties if inhaled),
   Specific target organ toxicity (STOT)-single exposure category 3 (H335: may cause respiratory irritation),
   Hazardous to the aquatic environment-acute hazard—Category 1 (H400: Very toxic to aquatic life),
   Hazardous to the aquatic environment—chronic hazard—Category 1 (H410: Very toxic to aquatic life with long lasting effects),
   Hazardous to the aquatic environment—chronic hazard—Category 2 (H411: Toxic to aquatic life with long-lasting effects.);
“very weakly corrosive”, a composition which has a corrosion rate less than 0.05 mm/year on aluminium alloys or stainless steels.
“cold stability”, a composition which retains its physical state and its intrinsic properties after storage for 18 weeks at a temperature <5° C.
“phosphorus-free”, a composition which preferably comprises less than 0.1% (m/m) phosphorus (P), still more preferably, which comprises no phosphorus.
“nitrogen-free”, a composition which preferably comprises less than 0.15% (m/m) nitrogen (N), still more preferably, which comprises no nitrogen.
   In the present description, the expression “comprises between . . . and . . . ” or “ranging from . . . to . . . ” should be understood as including the limits.

Active Substances

According to the invention, organic acid disinfectants of natural origin are used as active substances and in particular a mixture comprising, and preferably consisting of:
on the one hand, an aliphatic-chain fatty acid having 8 to 12 carbon atoms or a mixture of such acids; and
on the other hand, glycolic acid, being itself optionally in mixture with acetic acid.

An aliphatic-chain fatty acid having 8 to 12 carbon atoms is, in particular, a monocarboxylic acid with straight or branched alkyl chain, preferably a straight chain, having 8 to 12 carbon atoms. Such an acid can be chosen from the group consisting of octanoic acid, nonanoic acid, decanoic acid, preferably from octanoic acid and decanoic acid and will more preferably be octanoic acid (also named caprylic acid).

When the composition is in concentrated form, this fatty acid or the mixture of such acids can represent between 1 and 10% by mass of the mass of the composition, preferably between 1 and 5%, more preferably between 2 and 5%.

When said composition is in diluted form, the aliphatic-chain fatty acid having 8 to 12 carbon atoms or the mixture of such acids represents between 0.02 and 0.2% by mass of the mass of the composition, preferably between 0.02% and 0.1%, more preferably between 0.04 and 0.1%.

Glycolic acid is preferably used alone, but it can also be used in mixture with acetic acid in ratios by mass varying from 4:1 to 2:1.

When the composition is in concentrated form, glycolic acid, optionally in mixture with acetic acid, represents between 0.5% and 20% by mass of the mass of the composition, preferably between 0.5% and 15%, more preferably between 0.5% and 10%, and still more preferably between 0.5% and 2%.

When said composition is in diluted form, glycolic acid, optionally in mixture with acetic acid, represents between 0.01% and 0.40% by mass of the mass of the composition, preferably between 0.01% and 0.30%, more preferably between 0.01% and 0.20%, and still more preferably between 0.01% and 0.04%.

The two components forming the active substances of the composition according to the invention can be used in varied relative proportions. Advantageously, the mass ratio between the aliphatic-chain fatty acid having 8 to 12 carbon atoms or the mixture of such acids and glycolic acid, optionally in mixture with acetic acid, is between 20/1 and 5/1, preferably between 15/1 and 5/1, more preferably between 10/1 and 5/1.

The pH-Regulating Acid System

The active substances chosen in the context of the invention have an optimum efficacy when the composition is in the diluted state, which depends on the pH and the pathogen to be eliminated.

For this reason, these active substances should be combined within the composition according to the invention with a pH-regulating acid system, the type and amount of which are chosen such that the composition, in its diluted form, has a pH lower than the value of the pH for optimum efficacy, generally lower than 3.8, preferably lower than 2.0. This pH-regulating acid system is advantageously chosen from the group consisting of methane sulfonic acid, phosphoric acid, sulfuric acid, sulfamic acid and the mixtures thereof.

In order to further reduce the environmental impact of the composition according to the invention, this acid system advantageously consists of methane sulfonic acid. This acid, being nitrogen-free and phosphorus-free, has an excellent environmental profile and also possesses very good detergent and descaling properties.

In general:
when the composition is in concentrated form, the above-mentioned pH-regulating acid system represents between 5 and 50% by mass of the mass of the composition, preferably between 5 and 35%, more preferably between 10 and 30%; and
when the composition is in diluted form, the above-mentioned pH-regulating acid system represents between 0.1 and 1.0% by mass of the mass of the composition, preferably between 0.1% and 0.7%, more preferably between 0.2 and 0.6%.

In the case where the pH-regulating acid system consists of methane sulfonic acid, it has been determined that this acid must preferably be used in an amount between 5 and 30%, preferably between 7.5 and 20%, more preferably between 10 and 15%, still more preferably between 10.5 and 12%, of active material within the composition in its concentrated form. Hence, it has been observed that for a concentration of this acid less than 5%, the composition did not guarantee optimum efficacy of the organic acids against the pathogens, in its diluted form. In order to obtain optimum efficacy of the organic acids used, in particular against yeasts, it is, notably, necessary to guarantee a pH lower than approximately 2.0 on dilution.

Solubilising System

In order to solve the technical problems described above and linked to the use of relatively short chain organic acids which are particularly hydrophobic and consequently extremely difficult to formulate cold in the form of a concentrated product, the inventors have discovered and implemented an original solubilising system comprising an ethoxylated fatty alcohol, or a mixture of such ethoxylated fatty alcohols and a PEG-PPG copolymer as defined above. Advantageously, this solubilising system consists of, for at least 99% by weight, and preferably 100% by weight, an ethoxylated fatty alcohol, or a mixture of such ethoxylated fatty alcohols and a PEG-PPG copolymer as defined above.

The ethoxylated fatty alcohols that can be used in the context of the invention, alone or in a mixture, satisfy the formula R—(O—C₂H₄)ₙ—OH in which R represents a linear or branched alkyl group having 6 to 12 carbon atoms and n represents an integer between 4 and 8.

Examples of such fatty alcohols include, in particular, ethoxylated hexane-1-ol ethoxylated octane-1-ol and ethoxylated decanol-1-ol.

When the composition is in concentrated form, the ethoxylated alcohol or the mixture of ethoxylated alcohols represents between 1 and 30% by mass of the mass of the composition, preferably between 1% and 20%, more preferably between 1 and 15% and still more preferably between 4 and 8%.

When said composition is in diluted form, the ethoxylated alcohol or the mixture of ethoxylated alcohols represents between 0.02 and 0.6% by mass of the mass of the composition, preferably between 0.02% and 0.4%, more preferably between 0.02 and 0.3% and still more preferably between 0.08 and 0.16%.

According to a currently preferred embodiment, an ethoxylated hexane-1-ol is used as the ethoxylated fatty alcohols, preferably the compound having the CAS number: 31726-34-8, and having a chain length of 6 carbon atoms, and an ethoxylation number equal to 5. Such a product is, for example, the product marketed under the name Lutensol CS 6250® by BASF, Rokanol H5® by PCC EXOL or Novel 6-6 Ethoxylate by SASOL.

It has been observed that this molecule, which has good emulsifying and detergent properties, not only participates in the solubilisation of the fatty acid but also ensures good stability of the composition when cold, in the concentrated state.

The second component of the solubilising system used according to the invention is a copolymer, the central part of which is composed of a polypropylene glycol (PPG) group surrounded by two polyethylene glycol (PEG) groups and responding to the formula:

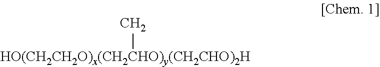

in which x represents an integer between 2 and 15, y represents an integer between 15 and 35, and z represents an integer between 2 and 15; or a mixture of such copolymers.

These copolymers (INCI name Poly(ethylene glycol)-block-poly(propylene glycol)-block-poly(ethylene glycol)) are generally used for their anti-foaming properties.

Preferably, in the context of the invention, copolymers are chosen for which the molar mass of the poly(propylene glycol) central block is between 870 and 2030, preferably between 1000 and 1800, more preferably between 1100 and 1750; and for which the percentage of poly(ethylene glycol) in the molecule is between 10 and 40%.

Entirely unexpectedly, it was discovered that these copolymers potentiate the solubilisation properties exerted by the ethoxylated fatty alcohols, not only within compositions intended to be applied under conditions where the foam must be controlled, but also in compositions intended to be applied under conditions requiring the formation of foams.

In general, these copolymers can be used in various proportions. A person skilled in the art will determine, in each particular case, the concentrations (mass/mass) making it possible to obtain compositions that are clear and stable on dilution.

Advantageously, when said composition is in concentrated form, the above-mentioned copolymer or the mixture of copolymers represents between 2 and 40% by mass of the mass of the composition, preferably between 2 and 30%, more preferably between 2 and 20% and still more preferably between 3 and 8%.
Advantageously, when said composition is in diluted form, the above-mentioned copolymer or the mixture of copolymers represents between 0.04 and 0.8% by mass of the mass of the composition, preferably between 0.04 and 0.6%, more preferably between 0.04 and 0.4% and still more preferably between 0.06 and 0.16%.

Examples of preferred copolymers may include, in particular, the products marketed under the commercial names, Pluronic PE 4300®, Pluronic PE 6100®, Pluronic PE 6200®, Pluronic PE 6400® by BASF, Genapol PF 10®, Genapol PF20® by Clariant, TB 6010®, TB 5031® by Ineos, Dowfax 63N10® by DOW, and Rokamer 2000® by PCC Exol.

The two components forming the solubilisation system of the composition according to the invention can be used in various relative proportions.

Advantageously, the mass ratio between the ethoxylated alcohol or the mixture of ethoxylated alcohols and the above-mentioned copolymer or the mixture of copolymers is between 5/1 and 1/5, preferably between 4/1 and 1/4, more preferably between 2/1 and 1/2.

Surfactant(s)

The choice of surfactants present in the compositions according to the invention varies, of course, according to the intended application.

Hence, in the case of use on an open surface, it is necessary to formulate a product having foaming properties which enable the application of the product for this type of use. Similarly, in the case of use in a washing tunnel or circuit, it will be necessary by contrast to obtain a control of the foam in order to obtain a weakly-foaming or non-foaming product.

In an original and advantageous manner, it has been shown that suitably chosen surfactant systems make it possible to formulate compositions intended for very different applications, while retaining the set of other constituents which have been described above.

According to a particular embodiment, a composition according to the invention intended for disinfecting open surfaces requiring the formation of foam can advantageously comprise a mixture of surfactants consisting of:
a foaming non-ionic surfactant or a mixture of such surfactants; and
an anionic surfactant, preferably a carboxylic acid ether of formula:

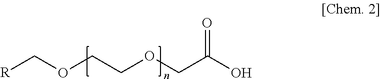

in which R represents an alkyl group having 12 to 16 carbon atoms, and n represents an integer between 2 and 12, preferably between 8 and 10, more preferably 10; or a mixture of such surfactants.

Examples of preferred, non-ionic, foaming surfactants include, in particular, cocamine oxide, such as, in particular, the products marketed under the names Oxydet DMCLD® by Kao, Genaminox 12 R® by Clariant, and Euroxyde LO/A® by EOC surfactant. Also included is myristamine oxide, such as, in particular, the products marketed under the names Kapanox MO® by Stepan and Flavol AOM® by Enaspol.

In general, this foaming non-ionic surfactant or this mixture of foaming surfactants will be used in various proportions in the compositions according to the invention intended for disinfecting open surfaces.

Hence, when the composition is in concentrated form, this surfactant or mixture of surfactants represents between 1 and 20% by mass of the mass of the composition, preferably between 1% and 15%, more preferably between 1 and 10% and still more preferably between 1 and 5%; and when said composition is in diluted form, this surfactant or mixture of surfactants represents between 0.02 and 0.4% by mass of the mass of the composition, preferably between 0.02% and 0.03%, more preferably between 0.02 and 0.2% and still more preferably between 0.02% and 0.1%.

Excellent results have been obtained by using, as foaming non-ionic surfactant, an alkyl amine oxide and, more particularly, dodecyldimethylamine oxide (CAS number: 308062-28-4), advantageously in an amount between 1 and 5% by mass of the mass of the composition in concentrated form.

This molecule is particularly appreciated for its good biodegradability, its high foaming power and the formation of a stable foam, its detergent and wetting properties and its good compatibility with other surfactants.

Examples of preferred anionic surfactants include, in particular, alkyl ether carboxylic acid, such as laureth-11 carboxylic acid (CAS number 27306-90-7), in particular the products marketed under the names Akypo RLM100® by Kao, and Empicol CBJ® by Innospec. Also included is laureth-6 carboxylic acid (CAS number 27306-90-7), in particular the products marketed under the name Akypo RLM 45® by Kao.

In general, the anionic surfactant or the mixture of anionic surfactants will be used in various proportions in the compositions according to the invention intended for disinfecting open surfaces.

Hence, when the composition is in concentrated form, this surfactant or mixture of surfactants represents between 1 and 30% by mass of the mass of the composition, preferably between 1% and 20%, more preferably between 1 and 10% and still more preferably between 1 and 5%; and when said composition is in diluted form, this surfactant or mixture of surfactants represents between 0.02 and 0.6% by mass of the mass of the composition, preferably between 0.02% and 0.4%, more preferably between 0.02 and 0.2% and still more preferably between 0.02% and 0.1%.

Excellent results have been obtained by using, as anionic surfactant, a carboxylic acid ether and more particularly the compound known under the INCI name Laureth-11 Carboxylic acid (CAS number: 27306-90-7), having a chain length of 12 atoms and a degree of ethoxylation of 10, advantageously in an amount between 1 and 5% by mass of the mass of the composition in concentrated form. This molecule is particularly interesting insofar as it has an excellent foaming property, with formation of a thick and stable foam, good biodegradability and an ecologically significant low value of aquatic toxicity.

In general, in such a composition intended for disinfecting open surfaces, the mass ratio between the foaming non-ionic surfactant or the mixture of such surfactants and the anionic surfactant, is between 20/1 and 1/1, preferably between 15/1 and 1/1, more preferably between 10/1 and 1/1.

According to another particular embodiment, a composition according to the invention intended for disinfecting washing tunnels or circuits requiring a control of the foam can advantageously comprise a weakly-foaming non-ionic surfactant or a mixture of such surfactants.

Examples of preferred weakly-foaming non-ionic surfactant can include, in particular, decyldimethylamine oxide (CAS number: 2605-79-0), such as, in particular, the products marketed under the names Tegotens DO® by Evonik, Colalux C-10@ by Colonial chemicals, and Barlox 10S® by Lonza. Also included are octyldimethylamine oxide, such as, in particular, Colalux C-8® by Colonial Chemicals, Genaminox OC® by Clariant, and Barlox 8S® by Lonza.

In general, this weakly-foaming non-ionic surfactant or this mixture of such surfactants will be used in varied proportions in the compositions according to the invention intended for disinfecting washing tunnels or circuits.

Hence, when the composition is in concentrated form, this surfactant or mixture of surfactants represents between 1 and 20% by mass of the mass of the composition, preferably between 1% and 15%, more preferably between 1 and 10%, and still more preferably between 1 and 5%; and when said composition is in diluted form, this surfactant or mixture of surfactants represents between 0.02 and 0.4% by mass of the mass of the composition, preferably between 0.02% and 0.3%, more preferably between 0.02 and 0.2% and still more preferably between 0.02 and 0.1%.

Excellent results have been obtained by using, as non-ionic surfactant, decyldimethylamine oxide (CAS number: 2605-79-0), advantageously in an amount between 1 and 5% by mass of the mass of the composition in concentrated form.

The main property of this molecule is that of being weakly foaming, but it also has good stability in an acid medium and good biodegradability.

The majority element from the quantitative point of view in the compositions according to the invention is of course water, including when these compositions are in concentrated form.

For this water, it is possible to use, for example, purified water such as distilled water, demineralised water, mains water or even industrial water.

When the composition is in concentrated form, water represents between 40 and 85% by mass of the mass of the composition, preferably between 50% and 80%, more preferably between 60 and 80% and still more preferably between 65 and 75%.

When said composition is in diluted form, water represents between 98.8% and 99.7% by mass of the mass of the composition, preferably between 99.0% and 99.6%, more preferably between 99.2 and 99.6%.

In general, the compositions in concentrated form are used after dilution to the necessary concentration (V/V) to enable a satisfactory application of the concentrated composition. The term “satisfactory application” shall mean the necessary dilution of the concentrated form, for which the desired microbiological efficacy is obtained for an open surface or closed circuit use.

According to a preferred embodiment, the compositions of the invention comprise, in concentrated form:
a fatty acid chosen from octanoic acid, decanoic acid and the mixtures thereof, preferably octanoic acid, in an amount between 1 and 5%, preferably between 2 and 5%
glycolic acid, in an amount between 0.5 and 10%, and preferably between 0.5% and 2%, and
methane sulfonic acid, in an amount chosen so that the composition, in its diluted form, has a pH lower than 3.8 and preferably lower than 2.0; in particular in an amount between 10 and 15%, preferably between 10.5 and 12%,
an ethoxylated fatty alcohol, preferably an ethoxylated hexane-1-ol in an amount between 1 and 15% and preferably between 4 and 8%
a copolymer such as defined above, in an amount between 2 and 20% and preferably between 3 and 8%
one or more surfactants, in an amount between 1 and 10% and preferably between 1 and 5%
water in an amount between 60 and 80% and preferably between 65 and 75%.
   These compositions will be able to be diluted for their final uses, for example to 2%.

Method for Preparing Compositions According to the Invention

The compositions according to the invention, which have just been described, can be prepared by conventional methods, on the industrial scale, for preparation of concentrated liquid disinfectant compositions, for example by mixing various compounds until a homogeneous mixture is obtained.

Advantageously, these compositions will be able to be prepared in a mixing reactor by implementing the following steps:
introducing water, the pH regulating system and glycolic acid, optionally in mixture with acetic acid;
mixing under stirring until a homogeneous liquid is obtained;
adding any surfactants;
mixing under stirring for a period of 5 to 20 minutes until a homogeneous liquid is obtained;
adding the ethoxylated fatty alcohol and the above-mentioned copolymer;
mixing under stirring for 3 to 10 minutes, until a homogeneous liquid is obtained;
adding the aliphatic chain fatty acid;
mixing under stirring for 3 to 10 minutes, until a homogeneous liquid is obtained.

### EXAMPLES

### Example 1: Example of a Composition According to the Invention for a Foaming Application

The following components, taken in the quantities mentioned, were mixed according to the describe protocol in compliance with the following table:

TABLE 1

| | Amount | Weighing |
|---|---|---|
| Components | (g)/kg | tolerance (g) |
| Demineralised water | 630.0 | ±0.1 |
| Methane sulfonic acid (70%) | 150.0 | ±0.1 |
| Glycolic acid (70%) | 10.0 | ±0.1 |

Mixing under stirring until a homogeneous liquid is obtained

| | | |
|---|---|---|
| Dodecyldimethylamine | 60.0 | ±0.1 |
| oxide (30%) | | |
| Laureth carboxylic acid | 10.0 | ±0.1 |
| ether (86%) | | |

Mixing under stirring for 10 minutes until a homogeneous liquid
is obtained

| | | |
|---|---|---|
| Ethoxylated hexane-1-ol | 60.0 | ±0.1 |
| Copolymer PE6200 | 50.0 | ±0.1 |

Mixing under stirring for 5 minutes until a homogeneous liquid
is obtained

| | | |
|---|---|---|
| Octanoic acid | 30.0 | ±0.1 |

Mixing under stirring for 5 minutes until a homogeneous liquid
is obtained

The concentrated product thus obtained has the following composition:

TABLE 2

| Example 1 | Quantity |
|---|---|
| Demineralised water | 72.1% |
| Methane sulfonic acid | 10.5% |
| Glycolic acid | 0.7% |
| Dodecyldimethylamine oxide | 1.8% |
| Laureth carboxylic acid ether | 0.9% |
| Ethoxylated hexane-1-ol | 6.0% |
| Copolymer PE6200 | 5.0% |
| Octanoic acid | 3.0% |

### Example 2: Example of a Composition According to the Invention for a Non-Foaming Application

By following the experimental protocol described in Example 1, the concentrated

product was prepared having the composition described in the table below.

TABLE 3

| Example 2 | Quantity |
|---|---|
| Demineralised water | 74.7% |
| Methane sulfonic acid | 10.5% |
| Glycolic acid | 0.7% |
| Dodecyldimethylamine oxide | 2.1% |
| Ethoxylated hexane-1-ol | 2.0% |
| Copolymer PE6200 | 7.0% |
| Octanoic acid | 3.0% |

### Examples 3 and 4: Other Examples of Compositions According to the Invention for a Foaming Application

TABLE 4

| | Example 3 | % | Example 4 | % |
|---|---|---|---|---|
| Water | Demineralised | 67.6% | Demineralised | 71.9% |
| | water | | water | |
| pH-regulating | Methane sulfonic | 15.0% | Methane sulfonic | 10.5% |
| system | acid | | acid | |
| Glycolic acid/ | Glycolic acid | 0.7% | Glycolic acid | 0.7% |
| acetic acid | | | | |
| Surfactant(s) | Dodecyldimethyl- | 1.8% | Dodecyldimethyl- | 3.0% |
| | amine oxide | | amine oxide | |
| | Laureth | 0.9% | Laureth | 0.9% |
| | carboxylic acid | | carboxylic acid | |
| | ether | | ether | |
| Ethoxylated | Ethoxylated | 6.0% | Ethoxylated | 7.0% |
| fatty alcohol | hexane-1-ol | | hexane-1-ol | |
| Copolymer | Copolymer | 5.0% | Copolymer | 3.0% |
| | PE6200 | | PE6200 | |
| Aliphatic-chain | Octanoic acid | 3.0% | Octanoic acid | 3.0% |
| fatty acid | | | | |

### Examples 5 and 6: Other Examples of Compositions According to the Invention for a Non-Foaming Application

TABLE 5

| | Example 5 | % | Example 6 | % |
|---|---|---|---|---|
| Water | Demineralised | 72.7% | Demineralised | 72.8% |
| | water | | water | |
| pH-regulating | Methane | 10.5% | Methane | 10.5% |
| system | sulfonic acid | | sulfonic acid | |
| Glycolic | Glycolic acid | 0.7% | Glycolic acid | 0.7% |
| acid/acetic acid | | | | |
| Surfactant(s) | Decyldimethyl- | 2.1% | Decyldimethyl- | 4.0% |
| | amine oxide | | amine oxide | |
| Ethoxylated | Ethoxylated | 4.0% | Ethoxylated | 4.0% |
| fatty alcohol | hexane-1-ol | | hexane-1-ol | |
| Copolymer | Copolymer | 7.0% | Copolymer | 5.0% |
| | PE6200 | | PE6200 | |
| Aliphatic-chain | Octanoic acid | 3.0% | Octanoic acid | 3.0% |
| fatty acid | | | | |

In their applications, these compositions will be used after dilution to concentrations between 0.5 and 3.0%, i.e. between 5 and 30 g/L for an open surface or closed circuit use. The degree of dilution will depend on the material used and the concentration (V/V) of active ingredients necessary in order to obtain a satisfactory result from a microbiological point of view.

Demonstrating the microbiological efficacy of the compositions according to the invention.

The microbiological efficacy of the compositions according to the invention has been demonstrated by following the experimental protocols defined according to the following standards:
EN 1276: Chemical disinfectants and antiseptics—Quantitative suspension test for the evaluation of bactericidal activity of chemical disinfectants and antiseptics used in food, industrial, domestic and institutional areas—Test method and requirements (phase 2, step 1)
EN 1650: Chemical disinfectants and antiseptics. Quantitative suspension test for the evaluation of fungicidal or yeasticidal activity of chemical disinfectants and antiseptics used in food, industrial, domestic and institutional areas.
   Test method and requirements (phase 2, step 1)
   Chemical disinfectants and antiseptics. Quantitative suspension test for the evaluation of fungicidal or yeasticidal activity of chemical disinfectants and antiseptics used in food, industrial, domestic and institutional areas.
EN 13697: Chemical disinfectants and antiseptics, Quantitative non-porous surface test for the evaluation of bactericidal and/or fungicidal activity of chemical disinfectants used in food, industrial, domestic and institutional areas
   Test method and requirements without mechanical action (phase 2, step 2) The composition of Example 1 was therefore evaluated and the following results were obtained:

TABLE 6

| | | Contact | | | | Effective |
|---|---|---|---|---|---|---|
| Formula | | time | Temperature | | | concentration |
| tested | Standard | (min) | (° C.) | Conditions | Strains | (V/V) |
| EXAMPLE | EN13697 | 15 | 20 | Clean | Candida | 2.0% |
| 1 | | | | | Albicans | |
| EXAMPLE | EN13697 | 30 | 20 | Clean | Candida | 1.5% |
| 1 | | | | | Albicans | |
| EXAMPLE | EN13697 | 15 | 20 | Clean | Staphylococcus | 0.5% |
| 1 | | | | | aureus | |
| EXAMPLE | EN13697 | 30 | 20 | Clean | Staphylococcuss | 0.5% |
| 1 | | | | | aureus | |
| EXAMPLE | EN13697 | 15 | 20 | Clean | Enterococcus | 0.5% |
| 1 | | | | | hirae | |
| EXAMPLE | EN13697 | 30 | 20 | Clean | Enterococcus | 0.5% |
| 1 | | | | | hirae | |
| EXAMPLE | EN13697 | 15 | 20 | Clean | Pseudomonas | 0.5% |
| 1 | | | | | aeruginosa | |
| EXAMPLE | EN13697 | 30 | 20 | Clean | Pseudomonas | 0.5% |
| 1 | | | | | aeruginosa | |
| EXAMPLE | EN13697 | 15 | 20 | Clean | Escherichia | 0.5% |
| 1 | | | | | coli | |
| EXAMPLE | EN13697 | 30 | 20 | Clean | Escherichia | 0.5% |
| 1 | | | | | coli | |
| EXAMPLE | EN13697 | 15 | 20 | Clean | Salmonella | 1.0% |
| 1 | | | | | Listeria | 1.0% |
| EXAMPLE | EN1276 | 15 | 20 | Clean | Salmonella | 0.5% |
| 1 | | | | | Listeria | 0.5% |
| EXAMPLE | EN1276 | 15 | 20 | Clean | Staphylococcus | 0.5% |
| 1 | | | | | aureus | |
| | | | | | Enterococcus | 0.5% |
| | | | | | hirae | |
| | | | | | Pseudomonas | 0.5% |
| | | | | | aeruginosa | |
| | | | | | Escherichia | 0.5% |
| | | | | | coli | |
| EXAMPLE | EN1650 | 15 | 20 | Clean | Candida | 1.5% |
| 1 | | | | | albicans | |

These results show that the composition of Example 1 has a bactericidal efficacy for a concentration of 0.5% (V/V) and a contact time of 15 minutes, at temperature 20° C., as well as a yeasticidal efficacy for a concentration of 2.0% (V/V) and a contact time of 15 minutes, at temperature 20° C.

In general, the compositions according to the invention have a bactericidal and yeasticidal efficacy for a concentration greater than or equal to 2% (V/V).

Demonstrating the influence of the pH on the efficacy of the compositions according to the invention

In order to demonstrate the influence of the pH on the efficacy of the compositions according to the invention, various compositions were prepared by varying the concentration (m/m) of pH regulator in the concentrated composition.

The following compositions have therefore been tested:

TABLE 7

| | Composition | Composition | Composition | Composition | Composition |
|---|---|---|---|---|---|
| | 32 | 35 | 36 | 37 | 38 |
| Demineralised water | 72.4% | 68.9% | 65.4% | 61.9% | 58.4% |
| Methane sulfonic acid | 3.5% | 7.0% | 10.5% | 14.0% | 17.5% |
| Glycolic acid | 3.5% | 3.5% | 3.5% | 3.5% | 3.5% |
| Dodecyldimethylamine | 3.6% | 3.6% | 3.6% | 3.6% | 3.6% |
| oxide | | | | | |
| Laureth carboxylic | 2% | 2% | 2% | 2% | 2% |
| acid ether | | | | | |
| Copolymer PE6200 | 12% | 12% | 12% | 12% | 12% |
| Octanoic acid | 3% | 3% | 3% | 3% | 3% |

These compositions were diluted in demineralised water at 20° C. The pH of the diluted solution thus obtained was measured for various dilutions, expressed as amount of dry matter of the concentrated composition in 1 L of diluted composition.

The results obtained are presented in the following tables:

TABLE 8

| Product concentration | | Acid concentrations | |
|---|---|---|---|
| (Composition 32) | | In solution | pH |
| 5 | g/L | Methane sulfonic acid: 0.175 g/L | 2.86 |
| | | Glycolic acid: 0.18 g/L | |
| | | Octanoic acid: 0.15 g/L | |
| 10 | g/L | Methane sulfonic acid: 0.35 g/L | 2.62 |
| | | Glycolic acid: 0.36 g/L | |
| | | Octanoic acid: 0.30 g/L | |
| 15 | g/L | Methane sulfonic acid: 0.525 g/L | 2.49 |
| | | Glycolic acid: 0.54 g/L | |
| | | Octanoic acid: 0.45 g/L | |
| 20 | g/L | Methane sulfonic acid: 0.70 g/L | 2.42 |
| | | Glycolic acid: 0.72 g/L | |
| | | Octanoic acid: 0.60 g/L | |
| 30 | g/L | Methane sulfonic acid: 1.05 g/L | 2.25 |
| | | Glycolic acid: 1.08 g/L | |
| | | Octanoic acid: 0.90 g/L | |

TABLE 9

| | | |
|---|---|---|
| Product concentration | Acid concentrations | |
| (Composition 35) | In solution | pH |

| | | | |
|---|---|---|---|
| 5 | g/L | Methane sulfonic acid: 0.35 g/L | 2.61 |
| | | Glycolic acid: 0.18 g/L | |
| | | Octanoic acid: 0.15 g/L | |
| 10 | g/L | Methane sulfonic acid: 0.70 g/L | 2.37 |
| | | Glycolic acid: 0.36 g/L | |
| | | Octanoic acid: 0.30 g/L | |
| 15 | g/L | Methane sulfonic acid: 1.05 g/L | 2.22 |
| | | Glycolic acid: 0.54 g/L | |
| | | Octanoic acid: 0.45 g/L | |
| 20 | g/L | Methane sulfonic acid: 1.40 g/L | 2.12 |
| | | Glycolic acid: 0.72 g/L | |
| | | Octanoic acid: 0.60 g/L | |
| 30 | g/L | Methane sulfonic acid: 2.10 g/L | 1.97 |
| | | Glycolic acid: 1.08 g/L | |
| | | Octanoic acid: 0.90 g/L | |

TABLE 10

| Product concentration | | Acid concentrations | |
|---|---|---|---|
| (Composition 36) | | In solution | pH |
| 5 | g/L | Methane sulfonic acid: 0.525 g/L | 2.49 |
| | | Glycolic acid: 0.18 g/L | |
| | | Octanoic acid: 0.15 g/L | |
| 10 | g/L | Methane sulfonic acid: 1.05 g/L | 2.21 |
| | | Glycolic acid: 0.36 g/L | |
| | | Octanoic acid: 0.30 g/L | |
| 15 | g/L | Methane sulfonic acid: 1.575 g/L | 2.04 |
| | | Glycolic acid: 0.54 g/L | |
| | | Octanoic acid: 0.45 g/L | |
| 20 | g/L | Methane sulfonic acid: 2.10 g/L | 1.94 |
| | | Glycolic acid: 0.72 g/L | |
| | | Octanoic acid: 0.60 g/L | |
| 30 | g/L | Methane sulfonic acid: 3.15 g/L | 1.82 |
| | | Glycolic acid: 1.08 g/L | |
| | | Octanoic acid: 0.90 g/L | |

TABLE 11

| | | |
|---|---|---|
| Product concentration | Acid concentrations | |
| (Composition 37) | In solution | pH |

| | | | |
|---|---|---|---|
| 5 | g/L | Methane sulfonic acid: 0.70 g/L | 2.29 |
| | | Glycolic acid: 0.18 g/L | |
| | | Octanoic acid: 0.15 g/L | |
| 10 | g/L | Methane sulfonic acid: 1.40 g/L | 2.06 |
| | | Glycolic acid: 0.36 g/L | |
| | | Octanoic acid: 0.30 g/L | |
| 15 | g/L | Methane sulfonic acid: 2.10 g/L | 1.91 |
| | | Glycolic acid: 0.54 g/L | |
| | | Octanoic acid: 0.45 g/L | |
| 20 | g/L | Methane sulfonic acid: 2.80 g/L | 1.84 |
| | | Glycolic acid: 0.72 g/L | |
| | | Octanoic acid: 0.60 g/L | |
| 30 | g/L | Methane sulfonic acid: 4.20 g/L | 1.75 |
| | | Glycolic acid: 1.08 g/L | |
| | | Octanoic acid: 0.90 g/L | |

TABLE 12

| Product concentration | | Acid concentrations | |
|---|---|---|---|
| (Composition 38) | | In solution | pH |
| 5 | g/L | Methane sulfonic acid: 0.875 g/L | 2.24 |
| | | Glycolic acid: 0.18 g/L | |
| | | Octanoic acid: 0.15 g/L | |
| 10 | g/L | Methane sulfonic acid: 1.75 g/L | 2.02 |
| | | Glycolic acid: 0.36 g/L | |
| | | Octanoic acid: 0.30 g/L | |
| 15 | g/L | Methane sulfonic acid: 2.625 g/L | 1.88 |
| | | Glycolic acid: 0.54 g/L | |
| | | Octanoic acid: 0.45 g/L | |
| 20 | g/L | Methane sulfonic acid: 3.50 g/L | 1.80 |
| | | Glycolic acid: 0.72 g/L | |
| | | Octanoic acid: 0.60 g/L | |
| 30 | g/L | Methane sulfonic acid: 5.25 g/L | 01:56 |
| | | Glycolic acid: 1.08 g/L | |
| | | Octanoic acid: 0.90 g/L | |

The efficacy of these compositions was determined by implementing the following test:
Standard: EN 13697
Strains: Candida albicans
Contact time: 15 minutes
Temperature: 20° C.
Cleanliness conditions: 0.3 g/L BSA (Bovine Serum Albumin)

The results obtained are reported in the following table, it being specified that a composition is considered to be effective when the observed reduction R is greater than 3.

TABLE 13

| Product | Composition | Composition | Composition |
|---|---|---|---|
| concentration (V/V) | 32 | 36 | 38 |
| 0.1% | R < 0.5 | R < 0.5 | R < 0.79 |
| | Not effective | Not effective | Not effective |
| | | | (pH = 2.24) |
| 0.5% | R = <0.5 | R = 0.52 | R = 1.07 |
| | Not effective | Not effective | Not effective |
| | | | (pH = 2.02) |
| 1% | R = 1.42 | R = 1.55 | R = 1.68 |
| | Not effective | Not effective | Not effective |
| | | | (pH = 1.88) |
| 1.5% | R = 2.13 | R = 2.71 | R = 2.60 |
| | Not effective | Not effective | Not effective |
| | | | (pH = 1.80) |
| 2.0% | R = 2.70 | R = 3.15 | R = 3.45 |
| | Not effective | Effective | Effective |
| 3.0% | R = 3.03 | R > 5.92 | R > 4.16 |
| | Effective | Effective | Effective |

An improvement in the efficacy can be observed for the compositions for which the methane sulfonic acid content is higher in the formulation. This increase in the acidity content has the consequence of lowering the pH at the dilution of use.

Carboxylic acids such as octanoic acid are Brönsted acids. They react with water to give carboxylate ions and oxonium ions.

The reaction progresses extremely quickly to an equilibrium state. The position of this equilibrium is a function of the acidity constant Kₐ of the acid-base pair, which only depends on the type of pair and the temperature. The higher Kₐ, the greater the formation of oxonium ions.

The pKa of octanoic acid is 4.85 (25° C.). The reduction in pH on dilution, makes it possible to find the octanoic acid in its predominant acid form which, in the desired case, increases its disinfectant properties.

Hence, it has been shown that in order to obtain an optimum efficacy of the organic acids used, in particular against yeasts, it is, in particular, necessary to guarantee a pH lower than 2.0 on dilution.

Demonstrating the effect of the copolymer on the solubilisation of the aliphatic-chain fatty acid.

The effect of various copolymers on the solubilisation of the octanoic acid and octanoic acid has been evaluated.
The following copolymers have therefore been evaluated.

TABLE 14

| | Copolymer | Copolymer | Copolymer | Copolymer |
|---|---|---|---|---|
| | PE4300 | PE6100 | PE6200 | PE6400 |
| Molar mass of | 1100 | 1750 | 1750 | 1750 |
| the propylene | | | | |
| glycol block | | | | |
| (g/mol) | | | | |
| % Polyethylene | 30 | 10 | 20 | 40 |
| glycol in the | | | | |
| molecule | | | | |

The results obtained are presented in the following tables.

TABLE 15
COPOLYMER PLURONIC PE 4300

| | Composi- | Composi- | Composi- | Composi- |
|---|---|---|---|---|
| | tion 11 | tion 12 | tion 13 | tion 14 |
| Demineralised water | 77% | 76% | 75% | 74% |
| Methane sulfonic acid | 10.5% | 10.5% | 10.5% | 10.5% |
| Glycolic acid | 0.7% | 0.7% | 0.7% | 0.7% |
| Dodecyldimethylamine | 1.8% | 1.8% | 1.8% | 1.8% |
| oxide | | | | |
| Laureth carboxylic | 1.0% | 1.0% | 1.0% | 1.0% |
| acid ether | | | | |
| Ethoxylated hexane-1-ol | 6.0% | 6.0% | 6.0% | 6.0% |
| Copolymer | 0.0% | 1.0% | 2.0% | 3.0% |
| PLURONIC PE4300 | | | | |
| Octanoic acid | 3% | 3% | 3% | 3% |
| Concentrated product | Cloudy | Cloudy | Cloudy | Clear |
| appearance | | | | |
| Appearance of 1.5% | Cloudy | Cloudy | Cloudy | Clear |
| dilution | | | | |
| (15 g/L) | | | | |

TABLE 16
COPOLYMER PE 6100

| | Composi- | Composi- | Composi- | Composi- |
|---|---|---|---|---|
| | tion 15 | tion 16 | tion 17 | tion 18 |
| Demineralised water | 77% | 76% | 75% | 74% |
| Methane sulfonic acid | 10.5% | 10.5% | 10.5% | 10.5% |
| Glycolic acid | 0.7% | 0.7% | 0.7% | 0.7% |
| Dodecyldimethylamine | 1.8% | 1.8% | 1.8% | 1.8% |
| oxide | | | | |
| Laureth carboxylic | 1.0% | 1.0% | 1.0% | 1.0% |
| acid ether | | | | |
| Ethoxylated hexane-1-ol | 6.0% | 6.0% | 6.0% | 6.0% |
| copolymer | 0.0% | 1.0% | 2.0% | 3.0% |
| PLURONIC PE6100 | | | | |
| Octanoic acid | 3% | 3% | 3% | 3% |
| Concentrated product | Cloudy | Cloudy | Cloudy | Clear |
| appearance | | | | |
| Appearance on dilution | Cloudy | Cloudy | Cloudy | Clear |
| 1.5% | | | | |
| (15 g/L) | | | | |

TABLE 17
COPOLYMER PE 6200

| | Composi- | Composi- | Composi- | Composi- |
|---|---|---|---|---|
| | tion 19 | tion 20 | tion 21 | tion 22 |
| Demineralised water | 77% | 76% | 75% | 74.5% |
| Methane sulfonic acid | 10.5% | 10.5% | 10.5% | 10.5% |
| Glycolic acid | 0.7% | 0.7% | 0.7% | 0.7% |
| Dodecyldimethylamine | 1.8% | 1.8% | 1.8% | 1.8% |
| oxide | | | | |
| Laureth carboxylic | 1.0% | 1.0% | 1.0% | 1.0% |
| acid ether | | | | |
| Ethoxylated hexane-1-ol | 6.0% | 6.0% | 6.0% | 6.0% |
| Copolymer | 0.0% | 1.0% | 2.0% | 2.5% |
| PLURONIC PE6200 | | | | |
| Octanoic acid | 3% | 3% | 3% | 3% |
| Concentrated product | Cloudy | Cloudy | Cloudy | Clear |
| appearance | | | | |
| Appearance of 1.5% | Cloudy | Cloudy | Cloudy | Clear |
| dilution | | | | |
| (15 g/L) | | | | |

TABLE 18
COPOLYMER PE 6400

| | Composi- | Composi- | Composi- | Composi- |
|---|---|---|---|---|
| | tion 23 | tion 24 | tion 25 | tion 26 |
| Demineralised water | 77% | 76% | 75% | 74% |
| Methane sulfonic acid | 10.5% | 10.5% | 10.5% | 10.5% |
| Glycolic acid | 0.7% | 0.7% | 0.7% | 0.7% |
| Dodecyldimethylamine | 1.8% | 1.8% | 1.8% | 1.8% |
| oxide | | | | |
| Carboxylic ether acid | 1.0% | 1.0% | 1.0% | 1.0% |
| Ethoxylated hexane-1-ol | 6.0% | 6.0% | 6.0% | 6.0% |
| Copolymer | 0.0% | 1.0% | 2.0% | 3.0% |
| PLURONIC PE6400 | | | | |
| Octanoic acid | 3% | 3% | 3% | 3% |
| Concentrated product | Cloudy | Cloudy | Clear | Clear |
| appearance | | | | |
| Appearance on dilution | Cloudy | Cloudy | Clear | Clear |
| 1.5% | | | | |
| (15 g/L) | | | | |

These results show the importance of the presence of the copolymer in the compositions according to the invention in order to ensure good solubilisation of the fatty acid, in this case, octanoic acid. The copolymer potentiates the solubilisation effect of the ethoxylated fatty alcohol.

Analogous results were obtained with decanoic acid, although in this case the amount of copolymer necessary to obtain good solubilisation is much higher.
It is therefore possible to solubilise fatty acids of different chain lengths with different types of copolymers, chosen in particular from the PLURONIC® range. A person skilled in the art will thus easily determine the amount and type of the copolymer to use, according to the type of fatty acid to be solubilised in the composition, but also as a function of the desired result according to the conditions of application of the invention.

Demonstrating the very low corrosive mass of the compositions according to the invention

The disinfectant compositions can be more or less corrosive in terms of the substrates on which they are applied and, in particular, those made of stainless steel or aluminium alloys that are usually found in the agro-food industry. This corrosion is manifest by a uniform dissolution of the metal surface in contact with the applied composition. It is generally evaluated by measurements of mass loss or thickness reduction of the metal at the surface of the substrate on which the composition is applied and expressed by a corrosion rate (mg or g per surface area and per time) or more often by a speed of corrosion (thickness reduction per unit time: mm/year).

In the case of a mass loss Δm during time Δt, the speed of corrosion V_{corr} is expressed

by the relation:

$$Vcorr = \frac{Δ m}{ρ \cdot S \cdot Δ t} \qquad [ Math . 1 ]$$

Where:
Vcorr: speed of corrosion (cm/year)
Δm/Δt: mass loss per unit time (g/year)
ρ: density of the metal (g/cm³)
S: surface area of the sample in contact with the liquid (cm²).

The corrosiveness of a composition is determined according to the following evaluation grid;

TABLE 19

| Speed of corrosion Vcorr (mm/year) | Degree of corrosiveness |
|---|---|
| <0.05 | Non-corrosive |
| <0.5 | Very weakly corrosive |
| 0.5 to 1.0 | Weakly corrosive |
| >1.0 | Corrosive |

The corrosiveness of the compositions according to the invention was therefore evaluated under the following experimental conditions:
Concentration (m/V): 3% (Dilution with demineralised water)
Contact time: 24 hours for aluminium—330 hours for Inox 304 L
Temperature: Ambient (approximately 20° C.)
Volume of solution: 500 mL
Aluminium reference coupon: Supplier: Sample—Ref: AE025100AA
Inox 304 L reference coupon: Supplier: Imotron—Ref: CO1011450104100

The results obtained are presented in the following table:

TABLE 20

| | Aluminium | | Inox 304L | |
|---|---|---|---|---|
| Contact time | 24 | hours | 330 | hours |
| Mass loss | 2.0 | mg | 0.9 | mg |
| Surface area | 50 | cm² | 25.81 | cm² |

| | | |
|---|---|---|
| Speed of corrosion | 0.054 | 0.011 |
| (mm/year) | | |
| Appearance of | No modification or | No modification or |
| the coupon | visual alteration of | visual alteration of |
| | the surface state | the surface state |
| Level of corrosiveness | Very weakly corrosive | Non-corrosive |

These results show that the composition of Example 1 of the invention leads to a very weak corrosion of the stainless-steel alloys and aluminium alloys for a concentration (m/V) of 3%, which is higher than the usual conditions of use.

1. A liquid disinfectant composition in concentrated or diluted form, which comprises:
an aliphatic-chain fatty acid having 8 to 12 carbon atoms or a mixture of such acids,
glycolic acid, or a mixture of glycolic acid with acetic acid,
a pH-regulating acid system, the type and amount of which is chosen such that the composition, in its diluted form, has a pH lower than 3.8, said pH-regulating acid system being selected from the group consisting of methane sulfonic acid, phosphoric acid, sulfamic acid, sulfuric acid and the mixtures thereof,
an ethoxylated fatty alcohol of formula R—(O—C₂H₄)ₙ—OH in which R represents a linear or branched alkyl group having 6 to 12 carbon atoms and n represents an integer between 4 and 8, or a mixture of such ethoxylated fatty alcohols;
a copolymer of formula: 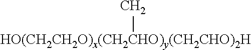
in which x represents an integer between 2 and 15, y represents an integer between 15 and 35, and z represents an integer between 2 and 15; or a mixture of such copolymers,
one or more surfactants,
and water.

2. The composition according to claim 1, wherein the aliphatic-chain fatty acid having 8 to 12 carbon atoms or the mixture of such acids is chosen from the group consisting of octanoic acid, nonanoic acid, decanoic acid and the mixtures thereof.

3. The composition according to claim 1, wherein the pH-regulating acid system is methane sulfonic acid.

4. The composition according to claim 1, wherein:
when said composition is in concentrated form, the aliphatic-chain fatty acid having 8 to 12 carbon atoms, or the mixture of such acids, represents between 1 and 10% by mass of the mass of the composition; and
when said composition is in diluted form, the aliphatic-chain fatty acid having 8 to 12 carbon atoms or the mixture of such acids represents between 0.02 and 0.2% by mass of the mass of the composition.

5. (canceled)

6. The composition according to claim 1, wherein:
when said composition is in concentrated form, the ethoxylated alcohol or the mixture of ethoxylated alcohols represents between 1 and 30% by mass of the mass of the composition; and
when said composition is in diluted form, the ethoxylated alcohol or the mixture of ethoxylated alcohols represents between 0.02 and 0.6% by mass of the mass of the composition.

7. The composition according to claim 1, wherein:
when said composition is in concentrated form, the above-mentioned copolymer or the mixture of copolymers represents between 2 and 40% by mass of the mass of the composition; and
when said composition is in diluted form, the above-mentioned copolymer or the mixture of copolymers represents between 0.04 and 0.8% by mass of the mass of the composition.

8. The composition according to claim 1, wherein:
when said composition is in concentrated form, the above-mentioned pH-regulating acid system represents between 5 and 50% by mass of the mass of the composition; and
when said composition is in diluted form, the above-mentioned pH-regulating acid system represents between 0.1 and 1.0% by mass of the mass of the composition.

9. The composition according to claim 1, wherein:
when said composition is in concentrated form, water represents between 40 and 85% by mass of the mass of the composition; and
when said composition is in diluted form, water represents between 98.8% and 99.7% by mass of the mass of the composition.

10. The composition according to claim 1, wherein the mass ratio between the aliphatic-chain fatty acid having 8 to 12 carbon atoms or a mixture of such acids and glycolic acid, or glycolic acid in mixture with acetic acid, is between 20/1 and 5/1.

11. The composition according to claim 1, wherein the mass ratio between the ethoxylated alcohol or the mixture of ethoxylated alcohols and the above-mentioned copolymer or the mixture of copolymers is between 5/1 and 1/5.

12. The composition according to claim 1, wherein said mixture of surfactants consists of:
a foaming non-ionic surfactant; and
a carboxylic acid ether of formula: 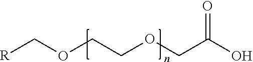
in which R represents an alkyl group having 12 to 16 carbon atoms, and n represents an integer between 2.5 and 12.

13. The composition according to claim 1, wherein said surfactant consists of
a weakly-foaming non-ionic surfactant.

14. A process for disinfecting open surfaces comprising using a composition according to claim 12.

15. A process for disinfecting in washing tunnels or in circuits comprising using a composition according to claim 13.

16. The composition according to claim 1, wherein the aliphatic-chain fatty acid having 8 to 12 carbon atoms is octanoic acid.

17. The composition according to claim 4, wherein:
when said composition is in concentrated form, the aliphatic-chain fatty acid having 8 to 12 carbon atoms, or the mixture of such acids, represents between 1 and 5% by mass of the mass of the composition; and
when said composition is in diluted form, the aliphatic-chain fatty acid having 8 to 12 carbon atoms or the mixture of such acids represents between 0.02 and 0.1% by mass of the mass of the composition.

18. The composition according to claim 17, wherein:
when said composition is in concentrated form, the aliphatic-chain fatty acid having 8 to 12 carbon atoms, or the mixture of such acids, represents between 2 and 5%; and
when said composition is in diluted form, the aliphatic-chain fatty acid having 8 to 12 carbon atoms or the mixture of such acids represents between 0.04 and 0.1%.

19. The composition according to claim 1, wherein:
when said composition is in concentrated form, glycolic acid or glycolic acid in mixture with acetic acid represents between 0.5 and 20%; and
when said composition is in diluted form, glycolic acid or glycolic acid in mixture with acetic acid represents between 0.01 and 0.40%.

20. The composition according to claim 19, wherein:
when said composition is in concentrated form, glycolic acid or glycolic acid in mixture with acetic acid represents between 0.5 and 2%; and
when said composition is in diluted form, glycolic acid or glycolic acid in mixture with acetic acid represents between 0.01 and 0.04%.

21. The composition according to claim 6, wherein:
when said composition is in concentrated form, the ethoxylated alcohol or the mixture of ethoxylated alcohols represents between 1 and 15%; and
when said composition is in diluted form, the ethoxylated alcohol or the mixture of ethoxylated alcohols represents between 0.02 and 0.3%.

22. The composition according to claim 21, wherein:
when said composition is in concentrated form, the ethoxylated alcohol or the mixture of ethoxylated alcohols represents between 4 and 8%; and
when said composition is in diluted form, the ethoxylated alcohol or the mixture of ethoxylated alcohols represents between 0.08 and 0.16%.

23. The composition according to claim 7, wherein:
when said composition is in concentrated form, the above-mentioned copolymer or the mixture of copolymers represents between 2 and 20%; and
when said composition is in diluted form, the above-mentioned copolymer or the mixture of copolymers represents between 0.04 and 0.4%.

24. The composition according to claim 23, wherein:
when said composition is in concentrated form, the above-mentioned copolymer or the mixture of copolymers represents between 3 and 8%; and
when said composition is in diluted form, the above-mentioned copolymer or the mixture of copolymers represents between 0.06 and 0.16%.

25. The composition according to claim 8, wherein:
when said composition is in concentrated form, the above-mentioned pH-regulating acid system represents between 5 and 35%; and
when said composition is in diluted form, the above-mentioned pH-regulating acid system represents between 0.1% and 0.7%.

26. The composition according to claim 25, wherein:
when said composition is in concentrated form, the above-mentioned pH-regulating acid system represents between 10 and 30%; and
when said composition is in diluted form, the above-mentioned pH-regulating acid system represents between 0.2 and 0.6%.

27. The composition according to claim 1, wherein:
when said composition is in concentrated form:
the aliphatic-chain fatty acid having 8 to 12 carbon atoms, or the mixture of such acids, represents between 1 and 10% by mass of the mass of the composition;
glycolic acid or glycolic acid in mixture with acetic acid represents between 0.5 and 20% the above-mentioned pH-regulating acid system represents between 5 and 50% by mass of the mass of the composition
the ethoxylated alcohol or the mixture of ethoxylated alcohols represents between 1 and 30% by mass of the mass of the composition
the above-mentioned copolymer or the mixture of copolymers represents between 2 and 40% by mass of the mass of the composition; and
when said composition is in diluted form:
the aliphatic-chain fatty acid having 8 to 12 carbon atoms or the mixture of such acids represents between 0.02 and 0.2% by mass of the mass of the composition;
glycolic acid or glycolic acid in mixture with acetic acid represents between 0.01 and 0.40%;
the above-mentioned pH-regulating acid system represents between 0.1 and 1.0% by mass of the mass of the composition;
the ethoxylated alcohol or the mixture of ethoxylated alcohols represents between 0.02 and 0.6% by mass of the mass of the composition; and
the above-mentioned copolymer or the mixture of copolymers represents between 0.04 and 0.8% by mass of the mass of the composition.

28. The composition according to claim 9, wherein:
when said composition is in concentrated form, water represents between 65 and 75%; and
when said composition is in diluted form, water represents between 99.2 and 99.6%.

29. The composition according to claim 10, wherein the mass ratio between the aliphatic-chain fatty acid having 8 to 12 carbon atoms or a mixture of such acids and glycolic acid, or glycolic acid in mixture with acetic acid, is between 10/1 and 5/1.

30. The composition according to claim 11, wherein the mass ratio between the ethoxylated alcohol or the mixture of ethoxylated alcohols and the above-mentioned copolymer or the mixture of copolymers is between 2/1 and 1/2.

31. The composition according to claim 1, wherein:
when said composition is in concentrated form:
the aliphatic-chain fatty acid having 8 to 12 carbon atoms, or the mixture of such acids, represents between 1 and 10% by mass of the mass of the composition;
glycolic acid or glycolic acid in mixture with acetic acid represents between 0.5 and 20% the above-mentioned pH-regulating acid system represents between 5 and 50% by mass of the mass of the composition
the ethoxylated alcohol or the mixture of ethoxylated alcohols represents between 1 and 30% by mass of the mass of the composition
the above-mentioned copolymer or the mixture of copolymers represents between 2 and 40% by mass of the mass of the composition; and
when said composition is in diluted form:
the aliphatic-chain fatty acid having 8 to 12 carbon atoms or the mixture of such acids represents between 0.02 and 0.2% by mass of the mass of the composition,
glycolic acid or glycolic acid in mixture with acetic acid represents between 0.01 and 0.40%
the above-mentioned pH-regulating acid system represents between 0.1 and 1.0% by mass of the mass of the composition
the ethoxylated alcohol or the mixture of ethoxylated alcohols represents between 0.02 and 0.6% by mass of the mass of the composition
the above-mentioned copolymer or the mixture of copolymers represents between 0.04 and 0.8% by mass of the mass of the composition; and
wherein the mass ratio between the aliphatic-chain fatty acid having 8 to 12 carbon atoms or a mixture of such acids and glycolic acid, or glycolic acid in mixture with acetic acid, is between 20/1 and 5/1; and
wherein the mass ratio between the ethoxylated alcohol or the mixture of ethoxylated alcohols and the above-mentioned copolymer or the mixture of copolymers is between 5/1 and 1/5.

32. The composition according to claim 12, wherein said mixture of surfactants consists of:
a dodecyldimethylamine oxide; and
a carboxylic acid ether of formula: 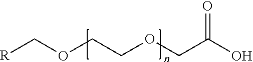
in which R represents an alkyl group having 12 to 16 carbon atoms, and n represents an integer between 8 and 10.

33. The composition according to claim 13, wherein said weakly-foaming non-ionic surfactant is decyldimethylamine oxide.
